(19) United States
(12) Patent Application Publication
(10) Pub. No.: US 2023/0321716 A1
(43) Pub. Date: Oct. 12, 2023

(54) CHAIN AND METHOD FOR MANUFACTURING A CHAIN

(71) Applicant: KAGA INDUSTRIES CO., LTD., Saitama-city Saitama (JP)

(72) Inventor: Yasunori TSUCHIGURO, Saitama-city Saitama (JP)

(73) Assignee: KAGA INDUSTRIES CO., LTD., Saitama-city Saitama (JP)

(21) Appl. No.: 18/041,546

(22) PCT Filed: Jul. 27, 2021
(86) PCT No.: PCT/JP2021/027718

§ 371 Date: Feb. 14, 2023

(30) Foreign Application Priority Data
Aug. 19, 2020 (JP) 2020-138428

(51) Int. Cl. B21L 9/04; B21L 9/06

(52) U.S. Cl. CPC B21L 9/04; B21L 9/06

(57) ABSTRACT

A chain has pairs of outer link plates provided with connecting pin-insertion connecting holes; connecting pins disposed in the connecting pin-insertion connecting holes and crimped at pin ends thereof; and inner link plates disposed inside and rotatably connected to the pairs of outer link plates. Each of the connecting pin-insertion connecting holes is provided with tapered surfaces at outer hole edges thereof formed by chamfering a corner edge formed by a straight hole. The tapered surfaces are located at two places opposing in a direction perpendicular to a longitudinal direction of the outer link plates. The pin ends of the connecting pins protruding outwardly from the connecting pin-insertion connecting holes are crimpled by pressing the pin ends against two places opposing in a direction perpendicular to the intermittently conveying direction to crimp the connecting pins at the segments where the tapered surfaces are provided.

### TECHNICAL FIELD

The present invention relates to a metal chain, such as a bush chain, a roller chain, and a leaf chain, in which a pair of outer link plates are disposed inside an inner link plate in an overlapping manner to joint together by crimping a connecting pin, and to a method for manufacturing a chain.

### BACKGROUND

For example, a metal chain such as a bush chain and a roller chain that transmits power by engaging tooth of a sprocket with the outer circumference of a bush or a roller loosely fitted onto the outside of the bush has the following configuration.

A roller chain is discussed by way of example, referring to the drawings showing the later described examples of the present invention and using the reference signs therein by way of example. The roller chain comprises: pairs of inner link plates 1; hollow tubular bushes 3 each press-fitted, at its ends, into bush-insertion connecting hole 2 of each pair of the inner link plates 1 to face and connect the inner link plates 1 to each other with a space therebetween; hollow tubular rollers 4 each rotatably fitted on an outside of each of the bushes 3 between the inner link plates 1; pairs of outer link plates 5 each disposed inside an end of each of the inner link plates 1 in an overlapping manner; and connecting pins 7 each inserted and disposed in each of the bushes 3 and inserted and disposed, at ends thereof, in connecting pin-insertion connecting holes 6 of each pair of the outer link plates 5 with portions of the ends slightly protruding outwardly from the connecting pin-insertion connecting holes 6 being crimped to connect the each pair of the outer link plates 5 to each other, wherein the inner link plates 1 and the outer link plates 5 are alternately and serially jointed together by means of the bushes 3 and the connecting pins 7 to form a long ring, so that the chain can be looped around, for example, a pair of sprockets, thereby allowing each of the tooth of the sprocket to engage with the outer circumference of each of the rollers 4 to transmit the power from one sprocket to the other sprocket.

In other words, such a chain can be, for example, a push chain or a roller chain that is formed in a long ring structure by, as described above, connecting a pair of inner link plates 1 with a bush 3 as well as connecting a pair of outer link plates 5 with a connecting pin 7, sequentially and alternately connecting pairs of the inner link plates 1 and pairs of the outer link plates 2, which overlap with each other at their respective ends, to form a long member, and, for example, connecting the ends of the long member together to form a long ring, wherein a pair of the outer link plates 5 are jointed together by crimping the ends of the connecting pin 7 inserted through the bush 3 and the inner link plates 1 are connected to the ends of the outer link plates 5 in an overlapping manner.

Therefore, such a chain has a configuration in which the pin ends are inserted and disposed in the connecting pin-insertion connecting holes 6 of the outer link plates 5 with the portions of the ends slightly protruding outwardly therefrom, which portions are crimped to connect the pair of the outer link plates 5 to each other as well as rotatably connect the inner link plates thereto at their mutually overlapping ends. The crimping causes a large pressing force to be applied to the right-angled corner of the hole edge of the connecting pin-insertion connecting hole 6, which leads to internal stress at the right-angle corner of the hole edge on the outside, which is the side the pin end is crimped, resulting in deviation and strain. This may cause a brittle fracture. In addition, when this internal stress is likely to accumulate to an unacceptable level, measures must be taken to resolve the problem.

### SUMMARY OF INVENTION

### Problem to Be Solved

The present invention solves these problems and aims to provide a metal chain having superior durability and a method for manufacturing such a chain by, for example, intermittently conveying the chain to a crimping machine and sequentially pressing and crimping the pin ends of the connecting pins at opposite positions perpendicular to a direction of the intermittent conveyance to connect a pair of outer link plates and connect inner link plates, thereby suppressing accumulation of internal stress in hole edges against which the pin ends are pressed and preventing cracks and brittle fractures from occurring.

### Solution to Problem

The details of the present invention will be described with reference to the accompanying drawings.

A chain according to the present invention has a configuration characterized by comprising: pairs of outer link plates 5 provided with connecting pin-insertion connecting holes 6; connecting pins 7 inserted and disposed in the connecting pin-insertion connecting holes 6 and crimped at pin ends thereof outside the connecting pin-insertion connecting holes 6 to connect each of the pairs of outer link plates 5 to each other; and inner link plates 1 disposed inside and rotatably connected to the pairs of outer link plates 5 in an overlapping manner, the pairs of outer link plates 5 being serially connected to one another via the inner link plates 1, wherein each of the connecting pin-insertion connecting holes 6 of the outer link plates 5 is provided with tapered surfaces 8 at multiple segments of outer hole edges thereof formed by chamfering a right-angle corner edge formed by a straight hole, the tapered surfaces 8 provided at the multiple segment are located at least at two places opposing in a shortitudinal direction perpendicular to a longitudinal direction of the outer link plates 5, which is also a chain length direction, and the pin ends of the connecting pins 7 inserted in and protruding outwardly from the connecting pin-insertion connecting holes 6 of the outer link plates 5 are crimpled by intermittently conveying the chain to a crimping machine in the chain length direction and pressing, by the crimping machine, the pin ends against at least two places opposing in a direction perpendicular to the intermittently conveying direction to crimp the connecting pins at the segments where the tapered surfaces are provided.

The chain may have a configuration characterize by further comprising bushes 3A inserted and disposed, at bush ends thereof, in bush-insertion connecting holes 2 of each pair of the inner link plates 1 to connect the inner link plates with a space therebetween, wherein the pairs of outer link plates 5 are disposed outside the ends of the inner plate link plates 5 in an overlapping manner, the connecting pins 7 are inserted and disposed in the bushes 3 and, at the pin ends thereof, in the connecting pin-insertion connecting holes 6 of the outer link plates 5 with portions of the pin ends outside the connecting pin-insertion connecting hole 6 being crimped to connect the each pair of the outer link plates 5 to each other, the inner link plates 1 and the outer link plates 5 are serially and alternately connected by the bushes 3 and the connecting pins 7, tooth of a sprocket are engaged with outer surfaces of the bushes or rollers 4 rotatably fitted onto the bushes 3 to transmit power, and the tapered surfaces 8 are provided at the multiple segments of the outer hole edge of each of the connecting pin-insertion holes 6 by chamfering the right-angle corner edge formed by the straight hole.

The chain may have a configuration characterized in that the tapered surfaces 8 provided at multiple segments of the outer hole edge of the connecting pin-insertion connecting holes 6 of the outer link plates 5 are formed by fracture surfaces on one of the hole edges fabricated when the connecting pin-insertion connecting holes 6 are formed through the outer link plates 5 by a drilling machine.

The chain may have a configuration characterized in that the fracture surfaces are fabricated at predetermined places by setting a clearance of a punch-receiving hole 10 provided on a die 9 of the drilling machine with respect to a punch 11 inserted into the punch-receiving hole 10, and the tapered surfaces 8 are formed at predetermined locations by the fracture surfaces.

A method for manufacturing a chain according to the present invention is characterized in that the chain has a configuration in which pairs of outer link plates 5 are provided with connecting pin-insertion connecting holes 6, connecting pins 7 are inserted and disposed in the connecting pin-insertion connecting holes 6 and crimped at pin ends thereof outside the connecting pin-insertion connecting holes 6 to connect each of the pairs of outer link plates 5 to each other, and inner link plates 1 are disposed inside and rotatably connected to the pairs of outer link plates 5 in an overlapping manner, the pairs of outer link plates 5 being serially connected to one another via the inner link plates 1, the method comprising: fabricating tapered surfaces 8, at multiple segments of outer hole edges of the connecting pin-insertion connecting holes 6 of the outer link plates 5, formed by chamfering a right-angle corner edge formed by a straight hole, the tapered surfaces 8 provided at the multiple segments being located at least at two places opposing in a shortitudinal direction perpendicular to a longitudinal direction of the outer link plates 5, which is also a chain length direction; intermittently conveying the chain to a crimping machine in the chain length direction; and pressing the pin ends of the connecting pins 7, which are inserted in and protruding outwardly from the connecting pin-insertion connecting holes 6 of the outer link plates 5, by the crimping machine against at least two places opposing in a direction perpendicular to the intermittently conveying direction to crimp the connecting pins at the segments where the tapered surfaces 8 are provided to connect each of the pairs of outer link plates 5 and rotatably connect the inner link plates 1.

The method for manufacturing a chain is characterized in that bushes 3A are inserted and disposed, at bush ends thereof, in bush-insertion connecting holes 2 of each pair of the inner link plates 1 to connect the inner link plates with a space therebetween, the pairs of outer link plates 5 are disposed outside the ends of the inner plate link plates 5 in an overlapping manner, the connecting pins 7 are inserted and disposed in the bushes 3 and, at the pin ends thereof, in the connecting pin-insertion connecting holes 6 of the outer link plates 5 with portions of the pin ends outside the connecting pin-insertion connecting hole 6 being crimped to connect the each pair of the outer link plates 5 to each other, the inner link plates 1 and the outer link plates 5 are serially and alternately connected by the bushes 3 and the connecting pins 7, and tooth of a sprocket are engaged with outer surfaces of the bushes or rollers 4 rotatably fitted onto the bushes 3 to transmit power, and the method further comprises providing the tapered surfaces 8 at the multiple segments of the outer hole edge of each of the connecting pin-insertion holes 6 by chamfering the right-angle corner edge formed by the straight hole.

The method for manufacturing a chain is characterized by forming the tapered surfaces 8, which are provided at multiple segments of the outer hole edge of the connecting pin-insertion connecting holes 6 of the outer link plates 5, by fracture surfaces on one of the hole edges fabricated when the connecting pin-insertion connecting holes 6 are formed through the outer link plates 5 by a drilling machine.

The method for manufacturing a chain is characterized by fabricating the fracture surfaces at predetermined places by setting a clearance of a punch-receiving hole 10 provided on a die 9 of the drilling machine with respect to a punch 11 inserted into the punch-receiving hole 10, and forming the tapered surfaces 8 at predetermined locations by the fracture surfaces.

### Effects of the Invention

The metal chain and the method for manufacturing a metal chain according to the present invention are configured as described above, so that, for example, when the chain is intermittently conveyed to the crimping machine and the pin ends of the connecting pins at positions opposing in a direction perpendicular to the direction of intermittent conveyance are sequentially pressed and crimped one after another to connect the pairs of outer link plates and the inner link plates, the accumulation of internal stress at the pressed hole edges is suppressed and cracks and brittle fractures are less likely to occur, resulting in a chain with excellent durability.

### BRIEF DESCRIPTION OF DRAWINGS

FIG. 1 is an illustrative perspective view of Example 1.

FIG. 2 is an illustrative front view of Example 1.

FIG. 3 is an illustrative front cross-sectional view of Example 1.

FIG. 4 is a front view of the primary portions of the crimping process carried out by the crimping machine of Example 1.

FIG. 5 is an illustrative side cross-sectional view of the state prior to drilling by the drilling machine of Example 1.

FIG. 6 is an illustrative side cross-sectional view of the state during drilling by the drilling machine of Example 1.

FIG. 7 is an illustrative plan view of the outer link plate of Example 1.

FIG. 8 is an illustration plan view of the punch receiving hole of the die of the drilling machine in Example 1, showing the dimensional settings of the punch receiving hole.

FIG. 9 is an illustrative front view of the leaf chain of Example 2.

FIG. 10 is an illustrative plan view of the leaf chain of Example 2.

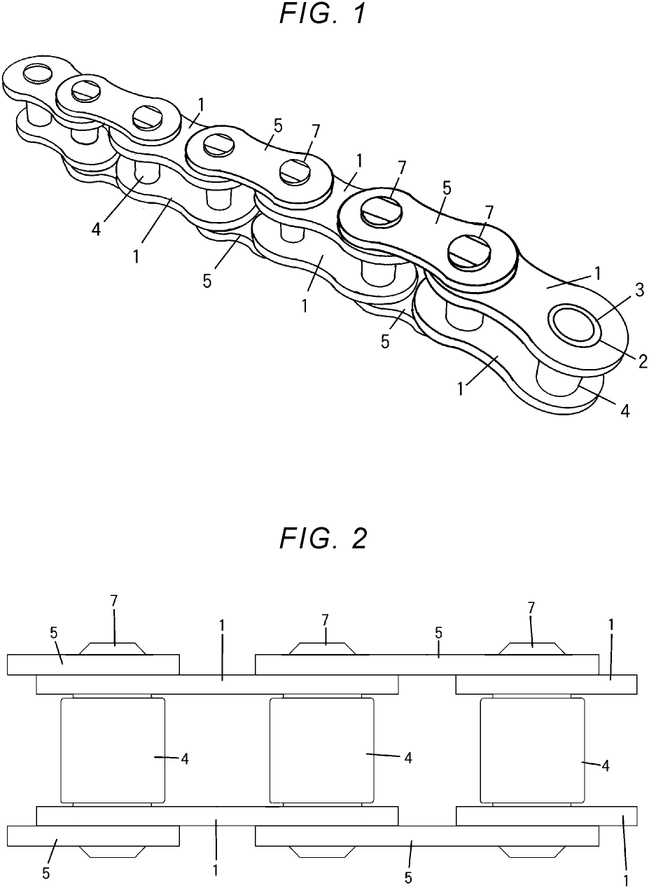

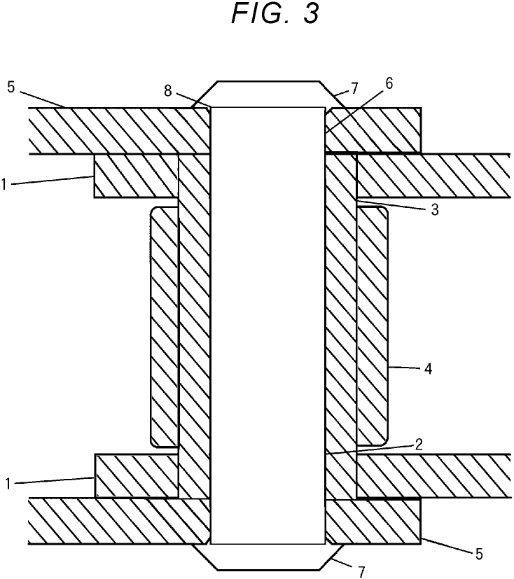

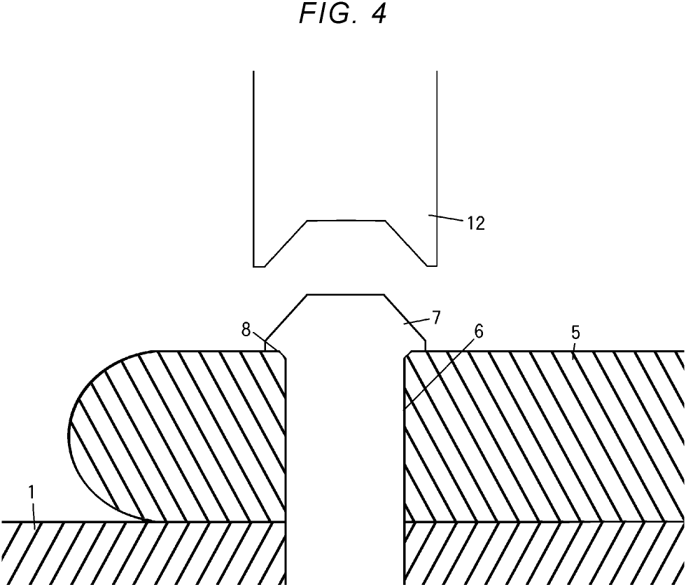

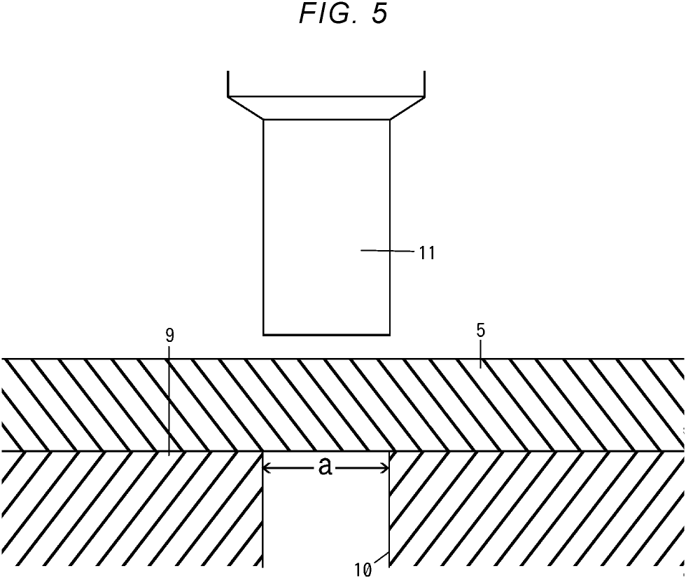

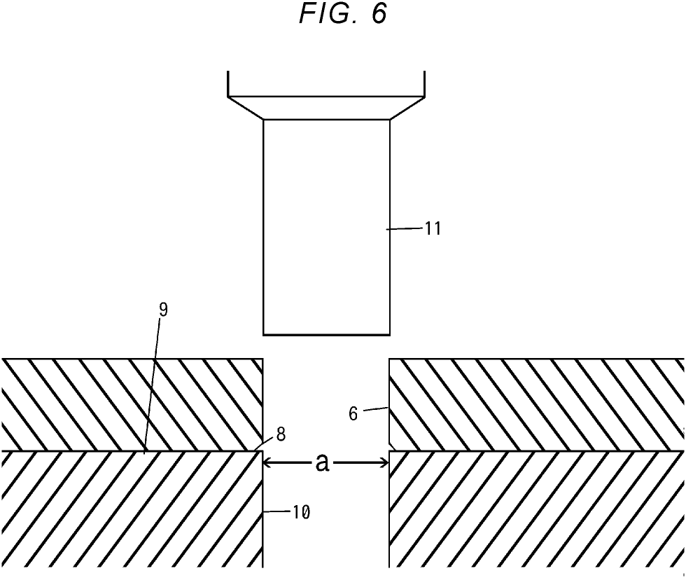

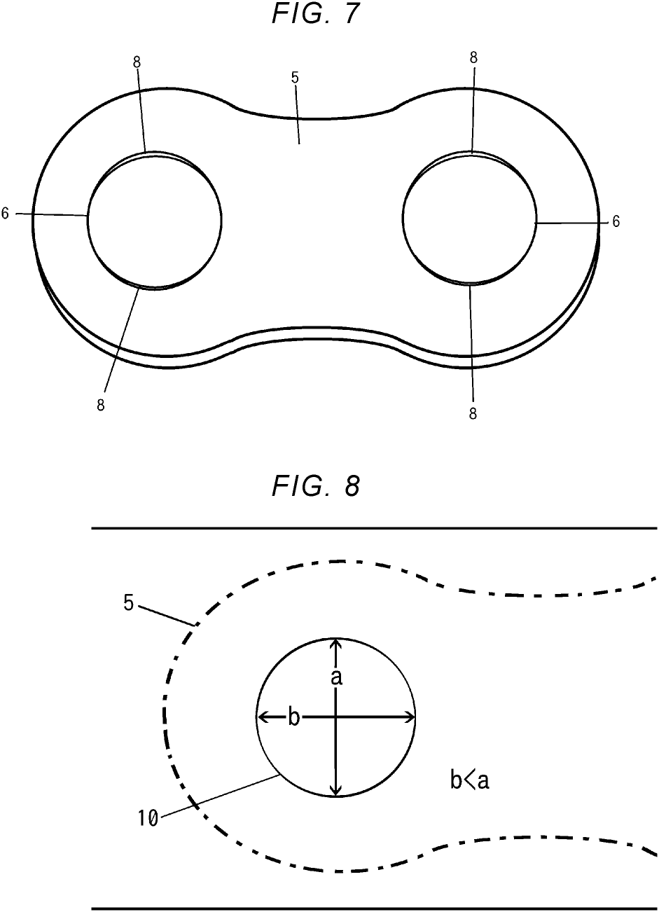

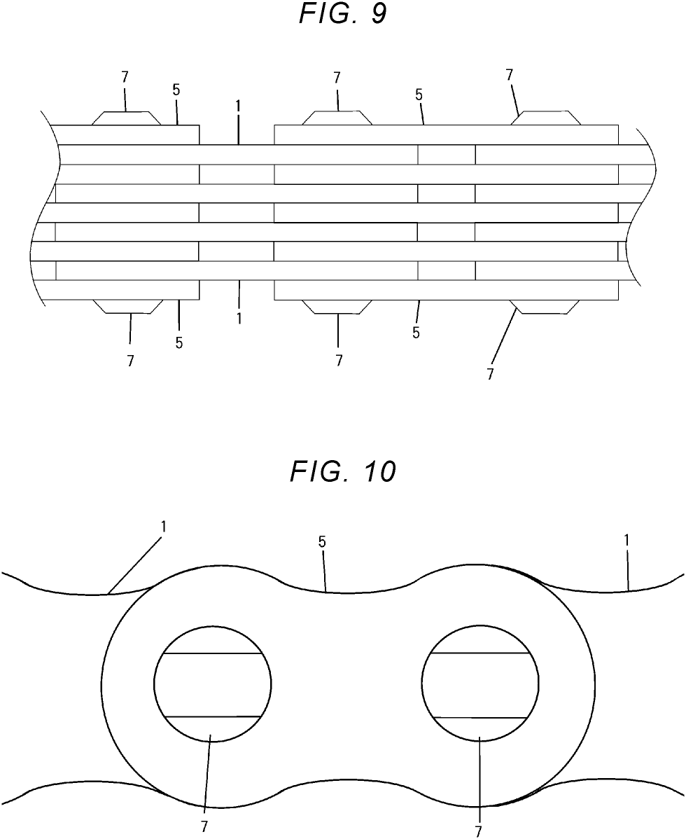

### DETAILED DESCRIPTION

The operation of the optimal embodiment of the present invention will be briefly described with reference to the drawings.

Connecting pins inserted and disposed in and slightly protruding outwardly from connecting pin-insertion connecting holes 6 of outer link plates 5 are crimped at pin ends to connect each of the pairs of outer link plates 5 to each other and rotatably connect inner link plates 1 inside thereof an overlapping manner.

For example, the chain is intermittently conveyed to the crimping machine and the pin ends of the connecting pins 7 at positions opposing in a direction perpendicular to the direction of intermittent conveyance are sequentially pressed and crimped one after another to connect the pairs of outer link plates 5 and connect the inner link plates 1 in an overlapping manner.

In this case, a large pressing force is applied to the hole edges of the connecting pin-insertion connecting holes 6 by this crimping operation. Since tapered surfaces 8 formed by chamfering corner edges are provided at positions of the hole edges against which the pin ends are pressed, the accumulation of internal stress is suppressed and cracks and brittle fractures are less likely to occur, resulting in a chain with excellent durability, as compared to the conventional configuration in which a large pressing force is applied to a right-angle corner edge formed simply by the straight hole.

Moreover, for example, when crimping is performed one after another while intermittently conveying the chain to the crimping machine as described above, two-point crimping, in which two places opposing in a direction perpendicular to the conveying direction are crimped by pressing with a press die 12 having, for example, a reverse V cross-section on the bottom surface, may be employed to allow for efficient crimping without defects, even if the accuracy of intermittent conveyance is not high. In other words, crimping the entire circumference is burdensome, and four-point crimping requires high conveyance accuracy and thus may result in inefficient and poor mass productivity, whereas two-point crimping, in which two places opposing in the direction perpendicular to the conveying direction, can improve the manufacturing efficiency.

Therefore, since the places where the large pressing force is applied are the two places opposing in the crimping direction such as, for example, the direction perpendicular to the conveyance direction as described above, by forming the hole edges of the connecting pin-insertion connecting holes 6 into tapered surfaces 8 rather than providing right-angled corner edges at these two predetermined opposite locations, the crimping is achieved by pressing against the tapered surface 8, which suppresses the accumulation of internal stress and prevents cracking and brittle fracture.

### Example 1

Specific Example 1 of the present invention will be described with reference to the drawings.

There are various types of chains, such as a bush chain, a roller chain in which rollers are loosely fitted to each bush, and a leaf chain in which multiple plates (inner link plates 1) are rotatably connected between outer plates (outer link plates 5) without using bushes or rollers. In this example, the present invention is applied to a stainless steel roller chain, which comprises: pairs of inner link plates 1; hollow tubular bushes 3 each press-fitted, at its ends, into bush-insertion connecting hole 2 of each pair of the inner link plates 1 to face and connect the inner link plates 1 to each other with a space therebetween; hollow tubular rollers 4 each rotatably fitted on an outside of each of the bushes 3 between the inner link plates 1; pairs of outer link plates 5 each disposed inside an end of each of the inner link plates 1 in an overlapping manner; and connecting pins 7 each inserted and disposed in each of the bushes 3 and inserted and disposed, at ends thereof, in connecting pin-insertion connecting holes 6 of each pair of the outer link plates 5 with portions of the ends slightly protruding outwardly from the connecting pin-insertion connecting holes 6 being crimped to connect the each pair of the outer link plates 5 to each other, wherein the inner link plates 1 and the outer link plates 5 are alternately and serially jointed together by means of the bushes 3 and the connecting pins 7 to form a long ring, so that the chain can be looped around, for example, a pair of sprockets, thereby allowing each of the tooth of the sprocket to engage with the outer circumference of each of the rollers 4 to transmit the power from one sprocket to the other sprocket.

In other words, a pair of inner link plates 1 are connected with a bush 3 and a pair of outer link plates 5 are connected with a connecting pin 7, and pairs of the inner link plates 1 and pairs of the outer link plates 2 are sequentially and alternately connected with the bush 3 and the connecting pin 7 at their respective ends in an overlapping manner to form a long member, and, for example, the ends of the long member are also jointed together to form a long ring.

In the present example, the pair of outer link plates 5 are connected together by crimping the pin ends of the connecting pin 7 inserted through the bush 3 with a roller 4 loosely fitted outside thereof from the outside of the outer link plates 5, and the ends of this inner link plates 1 are connected to the ends of the outer link plates 5 in an overlapping manner.

For example, in the present example, when crimping is performed one after another while intermittently conveying the chain to the crimping machine, two-point crimping, in which two places opposing in a direction perpendicular to the conveying direction are crimped, may be employed to allow for efficient crimping without defects, even if the accuracy of intermittent conveyance is not high. In other words, crimping the entire circumference is burdensome, and four-point crimping requires high conveyance accuracy and thus may result in inefficient and poor mass productivity, so that the present example employs two-point crimping in which two places opposing in the direction perpendicular to the conveying direction.

Therefore, since the places where the large pressing force is applied are the two places opposing in a direction perpendicular to the conveyance direction, the hole edges of the connecting pin-insertion connecting holes 6 are formed into tapered surfaces 8 rather than providing right-angled corner edges at these two predetermined opposite locations.

Consequently, the two-point crimping is achieved by pressing against the tapered surface 8, which suppresses the accumulation of internal stress and prevents cracking and brittle fracture.

In other words, the tapered surfaces 8 provided at the multiple segments are configured to be located at the two places opposing in a shortitudinal direction perpendicular to the longitudinal direction of the outer link plates 5, which is also the chain length direction, and are intermittently conveyed to the crimping machine in the chain length direction, and the pin ends of the connecting pins 7, which are inserted in and protruded outward from the connecting pin-insertion connecting hole 6 of the outer link plates 5, are pressed at two opposite points in the direction perpendicular to the intermittent conveyance direction by the crimping machine to achieve the two-point crimping. Since crimping is performed at the segments where the tapered surfaces are provided, internal stress is less likely to be generated at the hole edge than in the conventional configuration where the right-angled corner edge is strongly pressed, resulting in a chain with excellent durability.

In the present example, the tapered surface 8 provided at two locations on the outer hole edge of the connecting pin-insertion connecting hole 6 of the outer link plate 5 is formed by a fracture surface on one of the hole edges (hole edge from which the punch 11 exits) fabricated in a tapered surface shape when the connecting pin-insertion connecting hole 6 is formed through the outer link plate 5 by a drilling machine.

In other words, based on the recognition that the clearance of the punch-receiving hole 10 of the die 9 of the drilling machine with respect to the punch 11 results in forming the fracture surface in a tapered surface shape on the lower hole edge of the outer link plate 5 on the die 9, this phenomenon is proactively utilized such that the clearance is adjusted and set to allow the fracture surface to have a desired tapered surface.

It was found that, while a stainless steel chain has excellent corrosion resistance, brittle fracture is likely to be caused by internal stress due to its high hardness as mentioned above, and the internal stress is likely to occur and accumulate at the crimping positions. Thus, the chain is configured such that the right-angled corner edge of the hole edge is formed into the tapered surface 8.

The tapered surface 8 is formed by the fracture surface fabricated during the hole formation process. Since the fracture surface is a factor in gap corrosion, it has been a conventional practice that the fracture surface should not be generated significantly due to the increase in clearance derived from wear of the punch. However, in the case of the stainless steel chain according to the present invention, a fracture surface having a desired dimension is provided at the hole edge where a large pressing force is applied by crimping, and the fracture surface serves as a tapered surface 8. In this way, a configuration in which the tapered surface 8 is provided at the predetermined crimping position without requiring machining is achieved.

Furthermore, in the present example, the fracture surfaces having desired dimensions, which are to serve as the tapered surfaces 8, are fabricated at the above-mentioned two-crimping positions by setting a clearance of a punch-receiving hole 10 provided on a die 9 of the drilling machine with respect to a punch 11 inserted into the punch-receiving hole 10.

In other words, the present invention is based on not only the idea that a fracture surface, which is fabricated on the lower hole edge of the outer link plate 5 on the die 9 due to the clearance of the punch receiving hole 10 of the die 9 of the drilling machine with respect to the punch 11, is proactively utilized as the tapered surface 8, but also the finding that desired fracture surfaces can be formed only at predetermined locations by adjusting and setting the clearance. Thus, it is configured such that the tapered surfaces 8 formed by the fracture surfaces are provided at predetermined places on the hole edge by adjusting the size of the clearance.

More specifically, it was found that when the punch 11 is worn out with respect to the punch-receiving hole 10 and the clearance is enlarged, the fracture surface becomes significant. Based on this finding, the diameter of the punch-receiving hole is sized such that a diameter a of the outer link plate 5 in the shortitudinal direction is larger than a diameter b in the longitudinal direction by 1 to 2% to make the punch-receiving hole 10 to have, for example, a generally elliptical shape having such dimensions. By setting the clearance so as to directionally vary in size in this way, fracture surfaces formed by chamfering the right-angle corner edge of the hole edge are purposefully fabricated at two places of the lower hole opening opposing in the shortitudinal direction. Then, the outer link plate 5 is flipped upside down to make the hole opening at the side fabricated with the fracture surfaces face up, and the upper end of the connecting pin 7 inserted in and protruding from the hole opening is crimped at two places by a crimping machine to provide the tapered surfaces 8 formed by the fracture surfaces at the crimping positions.

### Example 2

The present invention may be applied not only to a bush chain or a roller chain as shown in the drawings but also to a crimping structure of an outer plate (outer link plate 5) of a leaf chain.

The invention is not limited to these examples, and the specific configuration of each constituent element can be designed appropriately.

REFERENCE SIGNS

| | |
|---|---|
| 1 | Inner link plate |
| 2 | Bush-insertion connecting hole |
| 3 | Bush |
| 4 | Roller |
| 5 | Outer link plate |
| 6 | Connecting pin-insertion connecting hole |
| 7 | Connecting pin |
| 8 | Tapered surface |
| 9 | Die |
| 10 | Punch receiving hole |
| 11 | Punch |

1-4. (canceled)

5. A method for manufacturing a chain, the chain having a configuration in which pairs of outer link plates are provided with connecting pin-insertion connecting holes, connecting pins are inserted and disposed in the connecting pin-insertion connecting holes and crimped at pin ends thereof outside the connecting pin-insertion connecting holes to connect each of the pairs of outer link plates to each other, and inner link plates are disposed inside and rotatably connected to the pairs of outer link plates in an overlapping manner, the pairs of outer link plates being serially connected to one another via the inner link plates, the method comprising: fabricating spaced-apart tapered surfaces, at opposing multiple segments of outer hole edges of the connecting pin-insertion connecting holes of the outer link plates, formed by chamfering a right-angle corner edge formed by a straight hole, the spaced-apart tapered surfaces provided at the opposing multiple segments being located at least at two places opposing in a shortitudinal direction perpendicular to a longitudinal direction of the outer link plates, which is also a chain length direction; adjusting a clearance of a punch-receiving hole provided on a die of the drilling machine with respect to a punch inserted into the punch-receiving hole to form the tapered surfaces at predetermined locations by the fracture surfaces; intermittently conveying the chain to a crimping machine in the chain length direction; and pressing the pin ends of the connecting pins, which are inserted in and protruding outwardly from the connecting pin-insertion connecting holes of the outer link plates, by the crimping machine against at least two places opposing in a direction perpendicular to the intermittently conveying direction to crimp the connecting pins at the segments where the tapered surfaces are provided to connect each of the pairs of outer link plates and rotatably connect the inner link plates.

6. The method for manufacturing a chain according to claim 5, wherein bushes are inserted and disposed, at bush ends thereof, in bush-insertion connecting holes of each pair of the inner link plates to connect the inner link plates with a space therebetween, the pairs of outer link plates are disposed outside the ends of the inner plate link plates in an overlapping manner, the connecting pins are inserted and disposed in the bushes and, at the pin ends thereof, in the connecting pin-insertion connecting holes of the outer link plates with portions of the pin ends outside the connecting pin-insertion connecting hole being crimped to connect the each pair of the outer link plates to each other, the inner link plates and the outer link plates are serially and alternately connected by the bushes and the connecting pins, and tooth of a sprocket are engaged with outer surfaces of the bushes or rollers rotatably fitted onto the bushes to transmit power, and the method further comprises providing the spaced-apart tapered surfaces at the opposing multiple segments of the outer hole edge of each of the connecting pin-insertion holes by chamfering the right-angle corner edge formed by the straight hole.

7-8. (canceled)
